(19) United States
(12) Patent Application Publication
(10) Pub. No.: US 2020/0354078 A1
(43) Pub. Date: Nov. 12, 2020

(54) AUTOMATED SAFETY SYSTEM FOR AIRCRAFT

(71) Applicant: BAE Systems plc, London (GB)

(72) Inventors: Paul Brooks, Farnborough (GB); Jonathan David Dixon, Farnborough (GB); Darryl James Sergison, Farnborough (GB)

(73) Assignee: BAE Systems plc, London (GB)

(21) Appl. No.: 16/641,487

(22) PCT Filed: Jul. 4, 2018
(86) PCT No.: PCT/GB2018/051883

§ 371 Date: Feb. 24, 2020

(30) Foreign Application Priority Data
Sep. 7, 2017 (GB) 1714364.5

(51) Int. Cl. B64D 47/06; G08G 5/00; B64C 39/02

(52) U.S. Cl. CPC B64D 47/06; G08G 5/0008; B64D 2045/0085; B64C 39/024; G08G 5/0013

(57) ABSTRACT

The invention is a self-contained, anti-collision safety system controller for high altitude, solar powered, unmanned aircraft. The controller acts as a backup to the primary safety system on the aircraft. It automatically turns on safety system equipment, such as a Mode S transponder and anti-collision lights when the aircraft descends below a pre-set pressure altitude. The pre-set altitude is chosen so that exceeds the altitude where other aircraft are operating and where collisions might occur. The controller measures the external air pressure to determine the aircrafts pressure altitude and activates/deactivates an internal switch between the power supply and the safety system equipment depending on whether the measured altitude exceeds the pre-set altitude level or not. The controller can be integrated into the exterior surface of an aircraft or internally within the airframe.

The present invention relates to a safety system controller for an aircraft and an aircraft having the same. The present invention also relates to a method of activating a safety device.

Unmanned aircraft operating at flight levels exceeding 60,000 feet within the stratosphere are commonly referred to as High Altitude Long Endurance (HALE) aircraft. HALE aircraft are characterized by their large wingspan (tens of meters), use of solar arrays for collecting the sun's energy, low power propulsion systems, low mass and high capacity, light weight batteries for power storage.

Aircraft operating in class A, B, C controlled airspace in the UK are required to carry safety systems to alert other uses of the airspace & air traffic services (ATS) to their location to avoid collisions between aircraft. Such systems include anti-collision lights and transponders. Passenger carrying aircraft are usually equipped with a second transponder in case of a failure of the primary transponder during flight. Additionally, navigation lights are carried to aid in visual identification of the direction of travel of an aircraft in flight.

Unmanned aircraft are subject to the same rules as manned aircraft if they operate in or fly through certain classes of controlled airspace. HALE aircraft must therefore be equipped with anti-collision lights and transponders to comply with air safety standards when flying through class A & C airspace on the way to the stratosphere. Once at stratospheric altitudes the risk of mid-air collision decrease as there are very few objects operating at these altitudes with which to collide.

HALE aircraft are largely flown by an onboard autopilot. Flight control and navigation system are controlled via radio or satellite links with manned ground stations. It is possible, therefore, that a failure in a communication link or the onboard controls systems could occur that would make the aircraft uncontrollable. Normally this type of failure case is addressed by the aircraft system being programmed to respond in a known, predictable manner. Part of that response is to turn the anti-collision lights and transponder on, if not already active.

Where a failure occurs in the safety system equipment itself or the power distribution system that the equipment is attached to the normal failure response may not be possible. In these circumstances if a backup safety system exists it can be activated to take over from the failed primary system. Unlike manned aircraft where a pilot can physically switch over to a backup system, unmanned aircraft may not be able do so if the command path has failed or the primary safety system failure cannot be autonomously detected.

The invention proposes a simple, self-contained, self-powered safety system that automatically activates when a HALE aircraft descends to an altitude where it may come into conflict with other commercial manned aircraft. This ensures that a safety system will always be operational in the event of a failure regardless of the type of failure experienced.

Primary safety systems are usually integrated with other aircraft systems e.g. avionics or power systems. Where this happens, the systems must be rigorously tested to ensure that the safety system operates correctly and is not compromised due to a failure in another system. Generally, the higher the degree of integration, the more complex the systems become. This can have the effect of lowering system reliability in operation and increases the testing required to verify that the system operate correctly in all circumstances.

By being self-contained and self-sufficient the invention can be tested independently of the rest of the aircraft's systems and would require fewer failure cases to be tested to verify that it performs as expected.

The proposed invention relates to the anti-collision safety system and its use in an unmanned, solar powered aircraft operating within the stratosphere for periods expected to exceed a year in duration. The invention is a standalone safety system controller comprised of a power source, a pressure detector, a switch, a light source, an aircraft transponder, a means of determining the aircraft's location and a housing. The controller is intended to act as a backup to a primary safety system which may be integrated with other aircraft system.

The controller is capable of being integrated into the external surface of an aircraft, specifically an unmanned, solar powered aircraft. In such cases the housing is designed to have an aerodynamic shape to reduce drag on the airframe. It may also be attached inside the airframe, in which case a non-aerodynamic housing can be substituted.

To comply with the safety requirements for flying in controlled airspace the transponder will, in practice, be a Mode S aircraft transponder with a set of aircraft anti-collision strobe lights as the light source. The preferred type of transponder is a Mode S ADS-B Out transponder.

Since there will be two transponders on an aircraft both must be set up to use identical ICAO 24-bit addresses and aircraft registration to identify the aircraft.

The transponder is attached to a means of obtaining the longitude, latitude & altitude of the aircraft if this is not integrated into the transponder itself. It is also connected to its own transmitting antenna. The positional information is required as part of the broadcasted information where the a Mode S ADS-B transponder is used.

The safety system controller is independent of all other systems in the aircraft as it is not physically connected to or controlled by any other systems. All parts of the controller derive their power from the controller's own power source and not from the power supply used by other aircraft components such as the avionics or propulsion systems. This ensures that the safety system will continue to function should there be a power failure in any other part of the aircraft.

The safety system is controlled by a pressure detector that is configured to activate a switch when it detects that it is below a pre-set altitude. The switch controls the power supply to the safety system components. Activation of the switch has the effect of turning on the transponder, anti-collision lights and means of obtaining locational information if this not integrated into the transponder. Above the selected altitude the switch is deactivated and power is no longer supplied to the safety system components thereby turning them off.

In operation, the safety system controller is active from take-off and until it attains the pre-set altitude. This ensures that the controller is working correctly. Prior to reaching the pre-set altitude the primary safety system is activated. At the pre-set altitude, the safety system controller turns off its safety equipment. During the operational phase of the flight is carried out using the primary safety system. When the aircraft descends below the pre-set altitude the safety system controller automatically detects the condition and activates the anti-collision lights and the transponder.

If the decent is for a controlled landing the primary safety system can, if required, be deactivate when the backup controller is activated. Where the decent is due to a failure that renders the aircraft uncontrollable the safety system controller will be activated automatically. In these circumstances if the primary safety system is still operating both primary & backup will broadcast location information and respond to ATS. This ensures that when descending at least one of the safety systems can advise ATS and other aircraft of the presence of the unmanned aircraft.

Since the safety system controller is designed as a simple self-contained unit it can be tested independently of the other systems on the aircraft thereby reducing the complexity of testing and the time taken to obtain approval for the aircraft's safety system.

According to an aspect of the present invention, there is provided a safety system controller which consists of:
a power source;
a pressure detector;
a switch;
a light source;
a means of communicating location to air traffic services and aircraft in the proximity of the controller;
a means to obtaining the location of the controller;
optionally, a housing.

The controller may be integrated into the exterior surface of an airframe.

The housing may be aerodynamically shaped.

The controller may be connected to the airframe by a means of attachment. The means of attachment may be an adhesive joint.

The power source may be a battery.

The pressure detector may be a pressure detector capable of measuring air pressure. The pressure detector may be configured to activate at a set pressure altitude. The detector may be a mechanical pressure switch. Alternatively, the detector may be an electronic or electrical pressure switch. The detector may be a barometric pressure switch.

The pressure detector may be connected to a switch. The pressure detector may activate/deactivate the switch. The switch may be a pressure switch.

The light source may be a plurality of aircraft anti-collision lights.

The means of communicating the aircraft's location may be a Mode S transponder and antenna. The aircraft transponder may be an ADS-B transponder.

The means to obtaining the current location of the controller may be a GNSS receiver and antenna. The receiver is integrated into the transponder. The receiver may be a GPS receiver. Alternatively, the receiver may be a Galileo receiver. The receiver may be a GLONASS receiver.

The power source may be connected to the pressure detector, the switch, the light source, the means to obtaining the location of the controller and the means of communicating location to air traffic services.

The safety system controller may be integrated into the interior of an airframe.

The light source may be located outside of the housing in some other part of the airframe and connected to the controller by a power connector.

The transponder antenna may be located outside of the housing in some other part of the airframe and connected to the transponder by a connector. The GNSS receiver antenna may be located outside of the housing in some other part of the airframe and connected to the GNSS receiver by a connector.

The pressure detector may be extended by a pressure detection tube that is connected the pressures detector to the external atmosphere by an aperture within the exterior surface of the airframe.

According to another aspect of the present invention, there is provided a safety system controller for an aircraft, the safety system controller comprising:
a safety means;
a power source for powering the safety means;
a pressure detector for detecting air pressure; and
a switch for activating the safety means,

wherein the pressure detector is arranged to close the switch to activate the safety means when the air pressure exceeds a value indicative of a pre-set altitude.

The pressure detector may be arranged to open the switch to deactivate the safety means when the air pressure decreases below a value indicative of the operating altitude of the aircraft being reached.

The switch may be arranged electrically between the power source and the safety means.

The safety means may comprise a transponder, a light source and a means for determining the location of the safety system controller. The means for determining the location may comprise a Global Navigation Satellite System [GNSS] receiver and antenna.

The safety system controller may comprise a housing, wherein the housing comprises the power source, pressure detector, transponder and switch. The light source, GNSS receiver and antenna, and a transponder antenna may be connected to the power source and the transponder through an aperture in the housing. The housing may further comprise the light source, GNSS receiver and antenna and a transponder antenna.

The housing may be permanently attached to an airframe of the aircraft using a low temperature adhesive.

The power source may be a battery.

According to another aspect of the present invention, there is provided an aircraft comprising the safety system controller according to the preceding aspect.

The aircraft may be configured to descend when a failure in a safety system is detected.

The aircraft may comprise a pressure detector tube extending to a point on the exterior surface of an airframe of the aircraft to allow the external air pressure to be sensed, the pressure detector tube being attached to the pressure detector and the switch.

The aircraft may be an unmanned solar-powered aircraft.

According to another aspect of the present invention, there is provided a method of activating a safety device for an aircraft, the method comprising:
detecting air pressure external to the aircraft;
closing a switch to activate a safety means if the air pressure is exceeds a value indicative of a pre-set altitude; and
opening the switch to deactivate the safety means when the air pressure decreases below a value indicative of the operating altitude of the aircraft being reached.

The invention is described by reference to two embodiments and the accompanying drawings in which:

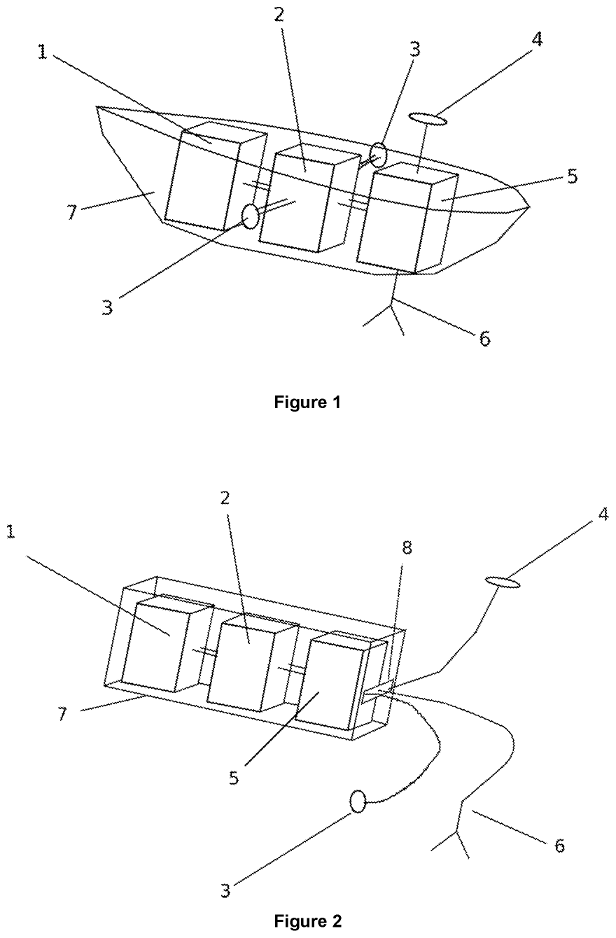

FIG. 1 A safety system controller in an external pod

FIG. 2 A safety system controller adapted to fit internally within the aircraft

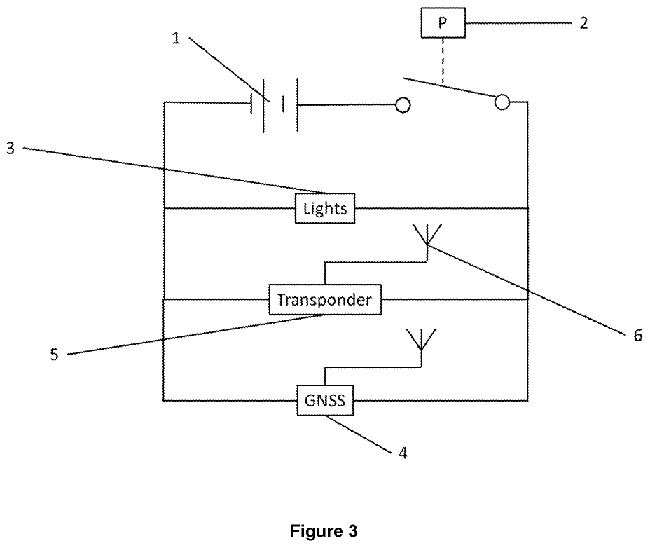

FIG. 3 A simple schematic of the safety system controller showing the pressure detector and switch.

FIG. 1 shows the preferred embodiment of the present invention which is a safety system controller which can be mounted on the external surface of a solar powered high altitude unmanned aircraft. The safety system controller consists of an outer aerodynamically shaped housing 7 containing a battery 1 power source, a pressure detector & switch 2, a pair of anti-collision lights 3, a Mode S ADS-B transponder with integrated Global Navigation Satellite System (GNSS) receiver 5, a transponder antenna 6 and a GNSS antenna 4. Further, the safety system controller comprises an outer aerodynamically shaped housing 7 containing a battery 1 power source, a pressure detector & switch 2, a pair of anti-collision lights 3, a Mode S ADS-B transponder with integrated Global Navigation Satellite System (GNSS) receiver 5, a transponder antenna 6 and a GNSS antenna 4. In other words, the safety system controller can have other components including for example wires.

The housing 7 is permanently attached to the airframe using a suitable low temperature adhesive and remains in place between flights. The housing is not air tight as the pressure detector 2 must be able to sense the external air pressure.

In the preferred embodiment the pressure detector 2 is a mechanical device which detects changes in the external air pressure and thereby measures the pressure altitude for the aircraft. Alternative implementation of the pressure detector would be a piezoelectric, solid state or a barometric pressure switch. Whichever implementation is chosen the detector reacts to the increase in air pressure by closing the switch at a pre-set altitude. The pressure detector is calibrated before flight so that the pre-set altitude corresponds to the upper flight level attainable by passenger carrying aircraft flying in controlled airspace.

During ascent, the altitude is less than the pre-set value for the detector it automatically closes the switch 2 that completes the electrical circuit show in FIG. 3 thereby connecting the of anti-collision lights 3, GNSS receiver 4 and the transponder 5 to the battery 1. These components of the safety system are themselves automatically activated when power from the battery 1 is applied causing the anti-collision lights 3 to be turn on, the transponder's GNSS receiver 4 to acquire locational information using its antenna and the transponder 5 to broadcast the aircraft's identity, position and altitude via it's dedicated antenna 6.

In the preferred embodiment, the GNSS receiver is a GPS receiver integrated into the transponder. Other GNSS that could be used include Europe's Galileo system or the Russian Federation's Global Orbiting Navigation Satellite System (GLONASS). When the operating altitude is reached the external air pressure decreases, the pressure detector opens the switch disconnecting the battery from the other components of the safety system. This turns off the safety system when the altitude exceeds the pre-set value.

Should a failure condition occur and the aircraft adopts its automated failure response it will, at some point, start to descend. When it descends to a level where the external air pressure is at or above the pressure for the pre-set altitude (e.g. when the aircraft descends into the normal operating altitude of civilian aircraft, which is between 30,000 and 42,000 feet) the switch closes completing the circuit and automatically turning on the anti-collision lights 3, the transponder & its GNSS receiver 4.

The design of the controller and the calibration of the spring in the pressure detector are all that are needed to allow the safety system to be turned on at the set altitude. Since the system is self-contained with no connection to any other aircraft system so it cannot be overridden from outside the safety system controller.

The second embodiment shown in FIG. 2 is a distributed safety system controller which consists of a core unit and a number of connectors. The core unit can be integrated into the internal structure of an unmanned high altitude aircraft.

In a comparable manner to the first embodiment the battery 1, pressure detector and switch 2 and a transponder 5 are contained within a housing 9, together they make up the core unit. The housing itself does not have any special aerodynamic qualities and can be constructed to fit the space within which it is to be positioned within the airframe as it merely acts as a container for the components within it.

Unlike the first embodiment the anti-collision lights 3, GNSS receiver & antenna 4 and transponder antenna 6 are integrated into other parts of the aircraft but are connected to the battery 1 and transponder 5 by connectors entering the housing though an aperture. Though these components are outside the housing 9 they are still powered from the battery 1 within the housing and control by the pressure detector & switch 2. This allows the anti-collision lights and antennas to be positioned optimally for the airframe.

In addition, a pressure detector tube is attached to the pressure detector & switch 2 and extends to a point on the exterior surface of the airframe to allow the external air pressure to be sensed.

The distributed safety system controller in FIG. 2 operates in the same way as described in the first embodiment.

What is claimed is:

1. A safety system controller for an aircraft, the safety system controller comprising:
a safety means;
a power source for powering the safety means;
a pressure detector for detecting air pressure; and
a switch for activating the safety means,
wherein the pressure detector is arranged to close the switch to activate the safety means when the air pressure exceeds a value indicative of a pre-set altitude.

2. The safety system controller according to claim 1, wherein the pressure detector is arranged to open the switch to deactivate the safety means when the air pressure decreases below a value indicative of the operating altitude of the aircraft being reached.

3. The safety system controller according to claim 2, wherein the switch is arranged electrically between the power source and the safety means.

4. The safety system controller according to claim 1, wherein the safety means comprises a transponder, a light source and a means for determining the location of the safety system controller.

5. The safety system controller according to claim 4, wherein the means for determining the location comprises a Global Navigation Satellite System (GNSS) receiver and antenna.

6. The safety system controller according to claim 4, wherein the safety system controller comprises a housing, wherein the housing comprises the power source, pressure detector, transponder and switch.

7. The safety system controller according to claim 6, wherein the light source, GNSS receiver and antenna, and a transponder antenna are connected to the power source and the transponder through an aperture in the housing.

8. The safety system controller according to claim 5, wherein the housing further comprises the light source, GNSS receiver and antenna and a transponder antenna.

9. The safety system controller according to claim 5, wherein the housing is permanently attached to an airframe of the aircraft using a low temperature adhesive.

10. The safety system controller according to claim 1, wherein the power source is a battery.

11. An aircraft comprising the safety system controller according to claim 1.

12. The aircraft according to claim 11, wherein the aircraft is configured to descend when a failure in a safety system is detected.

13. The aircraft according to claim 11, comprising a pressure detector tube extending to a point on the exterior surface of an airframe of the aircraft to allow the external air pressure to be sensed, the pressure detector tube being attached to the pressure detector and the switch.

14. The aircraft according to claim 11, wherein the aircraft is an unmanned solar-powered aircraft.

15. A method of activating a safety device for an aircraft, the method comprising:
detecting air pressure external to the aircraft;
closing a switch to activate a safety means if the air pressure is exceeds a value indicative of a pre-set altitude; and
opening the switch to deactivate the safety means when the air pressure decreases below a value indicative of the operating altitude of the aircraft being reached.

16. The safety system controller according to claim 2, wherein the safety means comprises a transponder, a light source and a means for determining the location of the safety system controller.

17. The safety system controller according to claim 3, wherein the safety means comprises a transponder, a light source and a means for determining the location of the safety system controller.

18. The safety system controller according to claim 5, wherein the safety system controller comprises a housing, wherein the housing comprises the power source, pressure detector, transponder and switch.

19. The safety system controller according to claim 6, wherein the housing is permanently attached to an airframe of the aircraft using a low temperature adhesive.

20. The safety system controller according to claim 7, wherein the housing is permanently attached to an airframe of the aircraft using a low temperature adhesive.
